(19) United States
(12) Patent Application Publication
(10) Pub. No.: US 2015/0106447 A1
(43) Pub. Date: Apr. 16, 2015

(54) Modular system and method for communicating information between different protocols on a control network

(71) Applicant: Edward Hague, Los Altos, CA (US)

(72) Inventor: Edward Hague, Los Altos, CA (US)

(21) Appl. No.: 14/121,748

(22) Filed: Oct. 14, 2014

Related U.S. Application Data
(60) Provisional application No. 61/890,743, filed on Oct. 14, 2013.
(60) Provisional application No. 61/895,994, filed on Oct. 25, 2013.

(51) Int. Cl. H04L 12/931; H04L 12/28

(52) U.S. Cl. CPC H04L 49/602; H04L 12/2803
USPC 709/204

(57) ABSTRACT

In a BACnet Internetwork, a modular concept is implemented to permit interchangeable protocol conversion between a host protocol like logic-level BACnet MS/TP and another protocol or function by providing pluggable communications modules that avoid tedious software configuration.

The present application claim priority from US provisional patent applications 61/890,743 filed Oct. 14, 2014 and 61/895,994 filed Oct. 25, 2013, both in the name of Edward Hague.

### FIELD OF THE INVENTION

The invention relates BACnet and LonWorks communications protocols and to data communication protocols in general, used for building automation and control networks.

### BACKGROUND OF THE INVENTION

Microcontroller based control systems, or devices, for buildings, industrial processes and other systems require inter control-system communications, or Control Networks. In building automation in particular, two main communication protocols exist: BACnet and LonWorks.

BACnet is a Data Communication Protocol for Building Automation and Control Networks developed under the auspices of the American Society of Heating, Refrigerating and Air-Conditioning Engineers (ASHRAE). BACnet is an American national standard, a European standard, a national standard in more than 30 countries, and an ISO global standard. The protocol is supported and maintained by ASHRAE Standing Standard Project Committee 135 (SSPC 135).

LonWorks was invented and is marketed, sold and supported by the Echelon Corporation.

Microcontroller based controller devices often control the Heating, Ventilation and Air Conditioning (HVAC), lighting, security, energy management and multiple other aspects of a modern“SmartBuilding”, campus, or city.

Data communications protocols such as BACnet are typically divided into protocol layers. BACnet can for instance be split into an upper logical layer, or software—only layer, and a lower physical layer. Controller Devices using BACnet communicate with each other and with host computer nodes using physical communications media (or layers) such as Ethernet or TIA-485-A [5] (or EIA-485, or RS-485). For ease of interoperability, the same upper, logical layer can typically be implemented on top of any of the lower physical layers in its family with little, if any, change.

LonWorks is typically used by Controller Devices to communicate with each other and with host computer nodes over physical communications media such as twisted-pair FT-10, MFT (megabit FT) and PLC/PL-20 (Power Line Communications). Like BACnet, LonWorks can be split into an upper logical, or software-only, layer and a lower physical layer, and the same upper, logical layer can be implemented on any of the lower physical layers in its family with little, if any change.

Each of the physical layers has its own advantages and disadvantages, and also, choosing a physical layer normally constrains the choice of the upper layers. For example, choosing a FT-10 physical layer normally constrains the upper layer to LonWorks.

Even though BACnet is emerging as the common standard, LonWorks is electrically advantageous in certain applications. Also, it is not always clear until perhaps the control systems are being specified by the end user, or even installed on site, which is the appropriate protocol to use. Also, during the lifecycle of any given building, the desired communications methodology or control network technology can change.

Original Equipment Manufacturers (OEMs) therefore have to make conflicting choices. They can either manufacture devices to support one or the other of the protocols, either BACnet or LonWorks, thus limiting their market to one or the other technology, or they can support both protocols in one device, thereby increasing their cost. Another option is to have two different models, or designs, thus increasing the number of models that need to be manufactured, stocked and supported.

One prior art approach is to provide a BACnet controller that defines a host BACnet protocol and wire it to a converter box (also referred to as a Gateway) that does protocol conversions, in order to support other high level protocols. However this requires a signal level conversion on the controller in order to send over the external wire, and then requires a second level conversion on the converter box for internal use on the converter box circuit to perform the protocol conversion. Examples are the family of BASRouters, which are routers used to route messages between BACnet/IP, BACnet Ethernet and BACnet MS/TP networks. Another example are the FieldServers (http://www.fieldserver.com/).

Plug-in converters have been developed, however these are pre-defined for specific output protocols and have pre-defined physical inputs. The BACnet controller therefore first has to be configured by software programming on an ad hoc basis in order to accommodate the plug-in converter, and does not speak logic-level BACnet MS/TP to the CPU on the controller device. An example of this is the ProtoCessor protocol converter and HMS Anybus (http://www.anybus.com/).

The Cimetrics B6001 is a router, based on the Lantronix XPort. It provides a BACnet/IP to BACnet MS/TP Router module that can be built into a product and routes BACnet communications between BACnet/IP and BACnet MS/TP local area networks. This is an ad hoc device that allows devices programmed to communicate BACnet MS/TP to communicate with devices on a BACnet/IP network. However it does not provide a replaceable modular solution for allowing a BACnet MS/TP device to communicate with any one of a variety of other protocols.

### SUMMARY OF THE INVENTION

According to the invention, there is provided a BACnet Internetwork, comprising multiple BACnet controller devices communicating with each other according to at least two different protocols, and at least one micro-router configured to convert between logic-level BACnet MS/TP communications protocol and a second communications protocol, wherein each micro-router defines a replaceable communications module that includes a first connector configured to releasably engage with a complementary connector on a controller device, and a second connector, the micro-router being connected to only one controller device via its first connector, and the controller device being configured as a BACnet MS/TP controller device in which communications between the micro-router and a CPU on the controller device take place according to logic-level BACnet MS/TP communications protocol.

The second connector may be configured to connect the micro-router to a second device or to a BACnet network, communicating according to a different communications protocol.

The micro-routers are preferably configured as dedicated modules that are interchangeably connectable to a BACnet controller device, and convert between the logic-level BACnet MS/TP on the first connector and said different communications protocol. The different communications protocol may comprise one of, BACnet MS/TP at a different voltage level, BACnet Ethernet, BACnet/IP, Modbus, USB, TIA-232, TIA-485-A, MoCA, IEEE 1901.2, IEEE1905, WiGig, LonWorks, wireless communications, and any communications protocol with added features, wherein the added features include at least one of BACnet COV, BACnet Security, and BACnet encryption, or diagnostic functions. The diagnostic function may include at least one of packet inspection, packet logging packet forwarding, and voltage level measurements.

The first connector may include contacts to provide support for ground or 0V, for power, and for at least one of TIA-485-A to accommodate a choice of the inverting ‘A’ signal and the non-inverting ‘B’ signal, USB 2.0, SPI, and logic-level SCI.

Further, according to the invention, there is provided a modular communications system for communicating data between a first controller device, communicating data according to a first communications protocol, and a second controller device or BACnet network, communicating data according to a second communications protocol, comprising a communications module, an adaptor for receiving the communications module, and a first controller device, wherein the communications module and adaptor are configured to releasably engage each other by means of complementary connectors and are configured to communicate with each other according to logic-level BACnet MS/TP communications protocol.

The communications module may be configured to convert between logic-level BACnet MS/TP and a second communications protocol, and the adaptor may be configured to communicate with the first controller device by means of a third communications protocol.

The first controller device may comprise a single board computer and the adaptor may include a header connector for connecting to the single board computer.

The second communications protocol may comprise one of, BACnet MS/TP at a different voltage level, BACnet/IP, Modbus, USB, TIA-232, TIA-485-A, MoCA, IEEE 1901.2, IEEE 1905, WiGig, LonWorks, wireless communications, and any communications protocol with added features, like BACnetCOV, BACnet Security, BACnet Trending and Scheduling, and diagnostic functions, and BACnet encryption.

Still further, according to the invention, there is provided a method of communicating between at least one first device connected to a first communications network and at least one second device in a BACnet Internetwork, comprising providing each of the at least one first devices with a dedicated micro-router, wherein each micro-router acts as a proxy for its first device by providing the MAC address for communications between its first device and any second device, and using only the BACnet Instance Number and BACnet Device Object Name of its first device for communications with said second device. Each micro-router and each first device may be provided with complementary connectors for releasably connecting a micro-router to a first devices.

### BRIEF DESCRIPTION OF DRAWINGS

FIG. 1 is a schematic representation of a typical prior art embedded controller device and its control network connections;

FIG. 2 is a schematic representation of one embodiment of an embedded controller device with different communications modules, of the invention;

FIG. 3-7 are schematic representations other embodiments of communications modules of the invention;

FIG. 8 is a schematic representation of another prior art controller device;

FIG. 9 is a schematic representation of an embodiment of a controller device and communications module of the invention;

FIGS. 10-11 are schematic representations other embodiments of communications modules of the invention;

FIGS. 12-14 show schematic representations of various embodiments of adaptors for use with communications module of the invention;

FIGS. 15-16 show schematic representations of two embodiments of module/adaptor arrangements for use as routers, gateways or bridges;

FIG. 17 shows a schematic representation of a USB adaptor in accordance with the invention;

FIG. 18 is a schematic representation of a prior art BACnet Internetwork, and

FIG. 19 is a schematic representation of one embodiment of a BACnet Internetwork with BACnet micro-routers of the invention

### DETAILED DESCRIPTION OF THE INVENTION

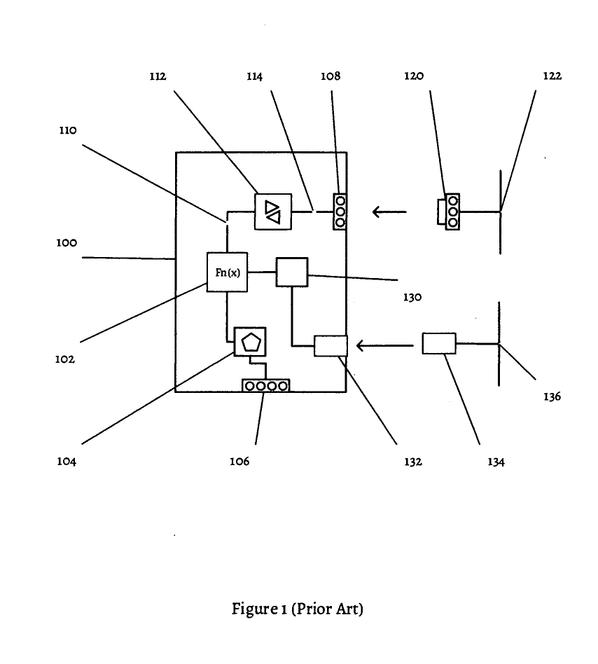

An example of a typical microcontroller based controller device used, for example, in building or industrial automation or as a component of the Internet of Things, is shown in FIG. 1 and indicated by reference numeral 100. The controller device 100 includes a microcontroller CPU Integrated Circuit (IC) “chip” or module 102, and electronic circuitry 104 to interface the controller device to physical sensors or meters providing inputs and outputs such as voltage, current, humidity, light, temperature, etc.

In order to connect to external physical inputs and outputs the controller device includes a connector 106. The controller device 100 also includes a network connector 108 adapted to connect to an external control network.

The line 110 shown in FIG. 1 portrays the logical communications links and electrical circuits between the CPU 102 and the Input/Output (I/O) interface integrated circuit 112. These links normally carry logic-level signals encoded to conform to a particular protocol, such as USB, SPI, SCI, Modbus, Echelon ShortStack/Microprocessor Interface Protocol (MIP) (which is available as parallel MIP and as serial MIP, and which carries their LonWorks protocol between chips), or BACnet MS/TP, which define a low level protocol and are collectively referred to herein as the Host Protocol. The controller device 100 may include only one type of link to support only one of the Host Protocols, or more than one protocol may be accommodated.

The I/O interface integrated circuit 112 includes electronic circuits that change logic level signals present on logical communications links and electrical circuits 110 to a different, more robust electrical level suitable for carrying data for long distances, in electrically noisy conditions, to other controller devices. For purposes of this embodiment, the integrated circuit 112 converts logic level signals to TIA-485-A (also known as RS-485, EIA-485-A), however it will be appreciated that in other embodiments it could be a circuit for converting to another physical protocol, such as TIA-232, etc. Also, it could be implemented in different ways. For instance, the electrical level conversion can be isolated or non-isolated.

The line 114 depicts circuitry carrying the robust electrical signals between the interface integrated circuit 112 and the connector 108. It will be appreciated that the data protocol on this connection is for all intents and purposes, the same logical protocols that exist on line 110, and it is normally only the electrical characteristics that are changed.

A connector 120 that is compatible with connector 108 on the controller device 100 provides the connector to a physical communications network 122, generically termed Control Network used to interconnect many controller devices. In this example of a prior art device, the network 122 is a TIA-485-A network.

The prior art controller device 100 includes a second interface circuit 130, which may include one or more integrated circuits. The interface circuit 130 changes logic level signals and protocols to a different, more robust electrical level suitable for carrying data for long distances, in electrically noisy conditions, to other controller devices. For the purposes of this example, the interface circuit 130 converts from logic level signals and protocols to 10/100baseT Ethernet. A modular jack 132 for Ethernet connections serves as a second network connector for controller device 100. A mating modular plug 134 for an Ethernet Control Network is shown connected to an Ethernet network 136. The Ethernet network 136 thus provides an alternative control network to the control network 122.

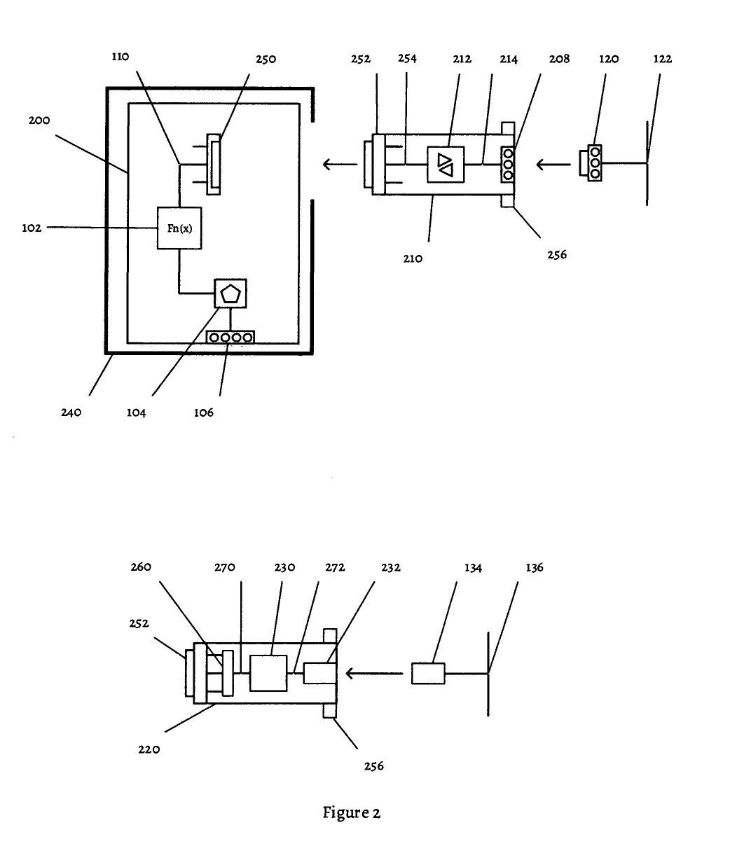

One embodiment of the invention will now be described with reference to FIG. 2. For ease of reference, the same reference numerals will be used to depict similar elements as in the prior art of FIG. 1. Instead of the usual level and protocol converting interfaces 112, 130 and connectors 108, 132, as found on the prior art, these elements are eliminated from the controller device 200, and instead communications modules 210, 220 are provided, which include level and protocol converting interfaces 212, 230, which are similar to the level converting interfaces 112, 130, and include connectors 208, 232, which are similar to the connectors 108, 132, of the prior art controller device. In its simplest form, the interfaces 212, 230 convert only the voltage levels, while in more complex embodiments they also convert the protocol. However, for ease of reference all of these conversions will be referred to herein as protocol conversions, and communications between one protocol and another. The line 214 depicts circuitry carrying the robust electrical signals between the interface integrated circuit 212 and the connector 208. It will be appreciated that the data protocol on this connection is for all intents and purposes, the same logical protocols that exist on line 110, and it is normally only the electrical characteristics that are changed.

The controller device 200 is normally installed in an enclosure 240 as shown in FIG. 2. The controller device is provided with an electrical connector 250, which supports the host protocol 110. For purposes of this application, the connector 250 will also be referred to as the communications module connector receptacle. In one embodiment, the connector 250 provides the mechanical and electrical commonality to a whole family of communications modules, such as the communications modules 210, 220 shown in this embodiment, and facilitates the modular concept of the present disclosure, as is discussed in greater detail below. The communications module connector receptacle 250, in this embodiment, is unique in that it provides a combination of all, or a subset of, electrical connections for power and ground, RS485, logic-level SPI and SCI busses and USB 2.0 bus simultaneously. In this embodiment 7+15 pin Mini SATA connectors have been chosen for use with the communications module connector receptacle 250, but alternatives implementations such as USB, and pin-header connectors are also contemplated.

The communications module 210 is provided with an electrical connector 252, also referred to herein as a communications module connector plug, which mates with connector 250, providing mechanical support and electrical connectivity between the controller device 200 and the communications module 210.

The circuit depicted by line 254 carries logic level signals defining the host protocol that is essentially the same as (or is connected to) the circuit 110 of the controller device 200 once the communications module 210 is installed into the controller device 200.

The communications modules of the disclosure, like those depicted by reference numerals 210, 220 in FIG. 2 are preferably provided with a common mechanical envelope, and a common electrical connector 252 as well as common mechanical mounting arrangement 256 so that they can easily be used interchangeably.

The mechanical mounting arrangement 256 allows the communications module 210 to be installed and secured into the controller device 200 and enclosure 240. The mounting arrangement supports the printed circuit board (PCB) of communications module 210 and allow attachment to any enclosure 240 that is used to house the controller device 200. The mounting arrangement may be implemented using any known suitable process such as injection molding or machining, with appropriate voids and holes for mounting screws, antennas, connectors and indicating LEDs. Cam type screws could be used to attach the module to the enclosure 240 thereby eliminating the need for screw holes in the enclosure 240, reducing cost of manufacture of the enclosure.

Thus the mechanical, protective enclosure 240 for controller device 200 acts as a mechanical mounting structure for controller device 200 as well as the mounting structure for communications module 210 via the mechanical mounting arrangement 256.

Depending on the application, the communications module 210 may or may not have protective covers or shields.

Module 220, in this embodiment, is similar to module 210, but designed to provide a conversion of the controller device host protocol to an Ethernet based protocol, such as, but not limited to BACnet/IP.

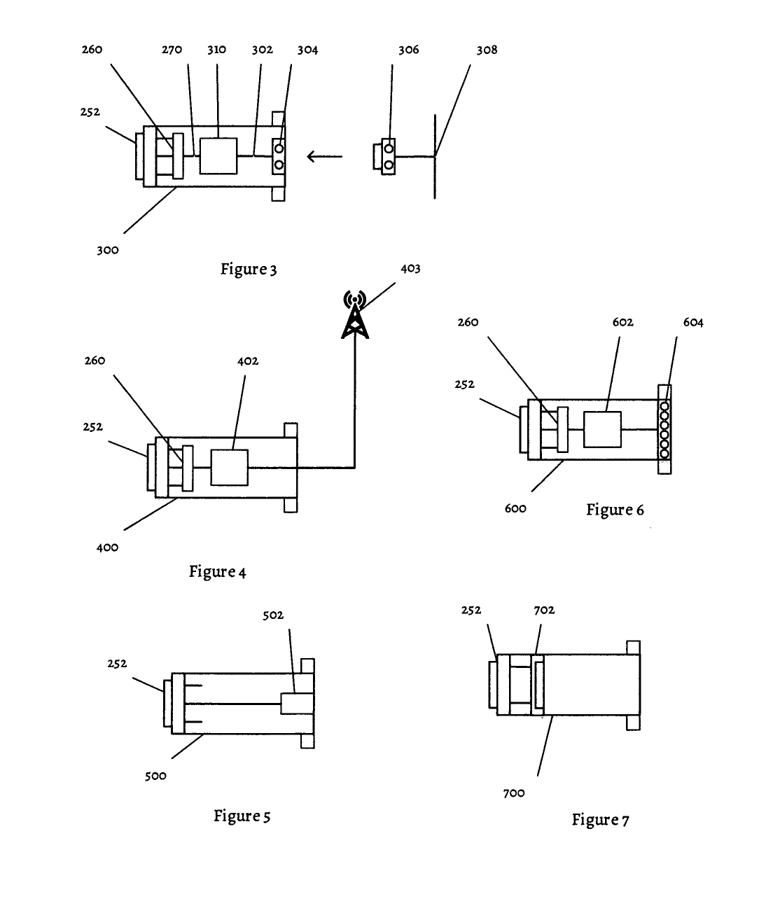

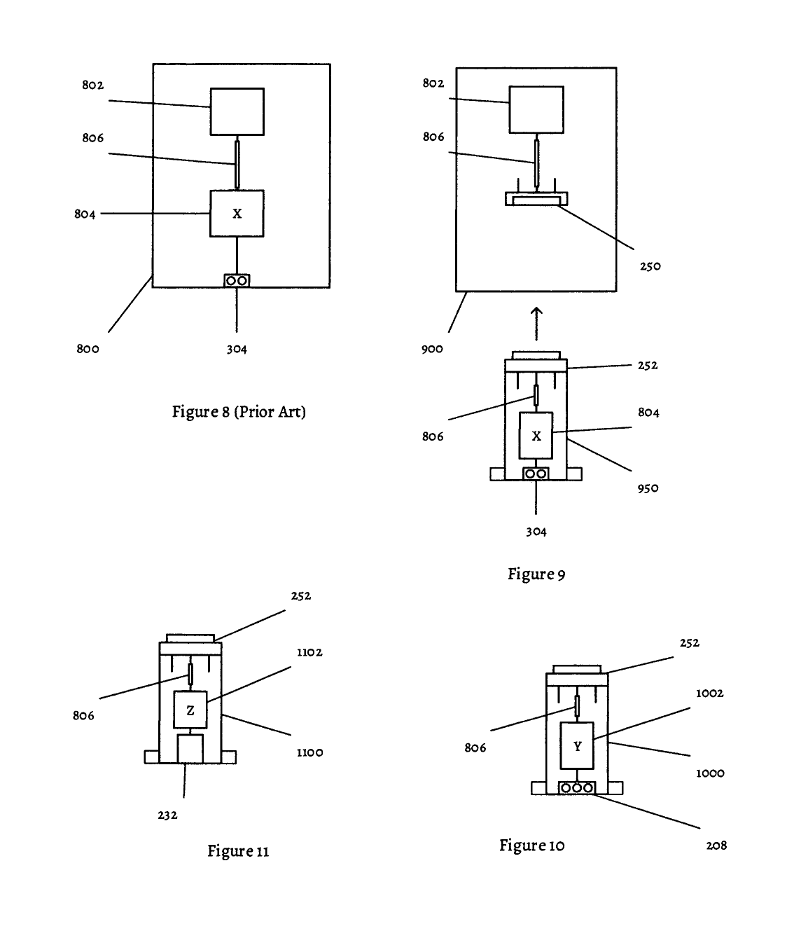

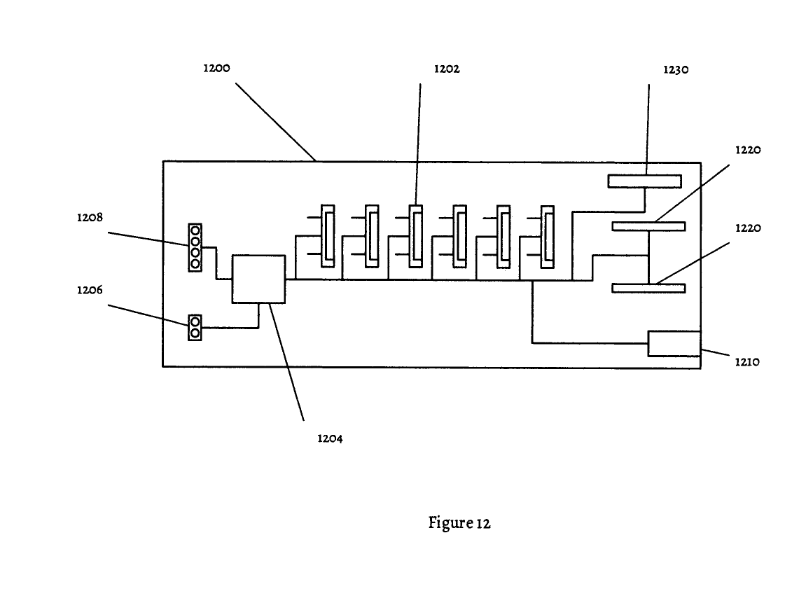

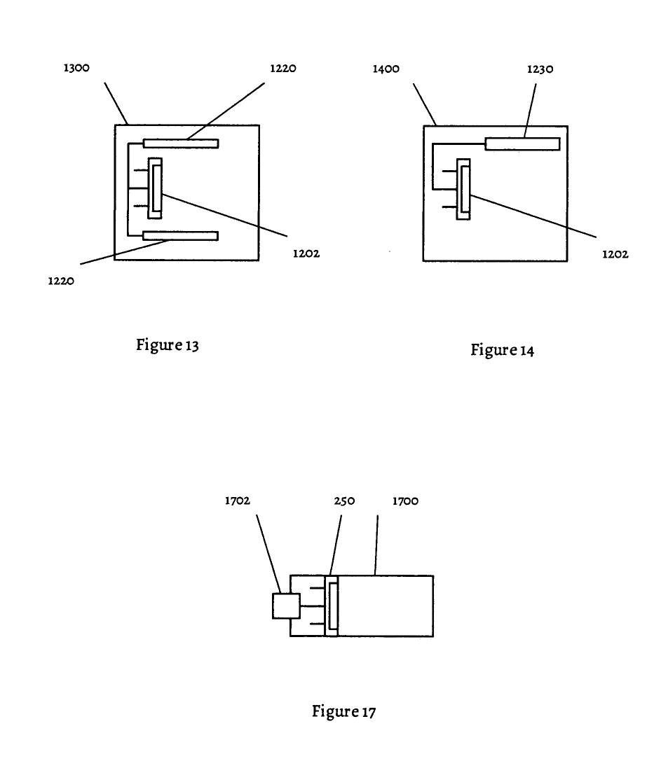

It includes electrical circuitry 260 to select and connect one, or more, of the many communication interfaces that are connected to the communications module connector 252 to the rest of the electronics 230 on the communications Module 220. In essence, the circuitry 260 allows the selection of the signals on connection 110 and presents this selection to the subsequent circuitry 230. As will be discussed further below, other embodiments make use of similar selection circuitry 260 to present the appropriate selection to the subsequent circuitry such as the subsequent circuitry 310, 402 in the embodiments of FIGS. 3 and 4, respectively.

The line 270 depicts a circuit carrying the selected connection or connections from the electronics 260 to the communications circuitry 230. The communications circuitry 230 can include multiple components, microcontrollers or modules that act to convert the electrical levels and data protocols presented by circuitry 270 to alternative electrical levels and data protocols. These are forwarded on to circuit 272. The circuitry 230 can also provide additional functionality to a protocol presented to it by circuit 270, and can present this protocol, with the added functionality to circuit 272. For example, circuit 270 could carry a basic BACnet MS/TP protocol, but the circuitry 230 could add BACnet COV (Change of Value) functionality, and present this to circuit 272. Another example of additional functionality includes the addition of a BACnet Security and/or encryption to unsecured and unencrypted BACnet. Yet other protocol conversions that can be performed by the circuitry 230 include Modbus to BACnet, BACnet to Modbus, USB to TIA-232 or to TIA-485-A, conversion from the Host Protocol to MoCA, IEEE 1901.2, IEEE 1905, WiGig, or LonWorks “MFT, etc. The circuitry 230 can also contain diagnostic electronics for troubleshooting the control network.

The circuit 272, which is depicted in FIG. 2 by a line, carries the forwarded alternative communication protocols presented by circuitry 230. Many different electrical (physical) and logical protocols combinations are possible here. In this embodiment the communications module 220 provides Ethernet 10/100baseT.

Another embodiment of a communications module of the invention is shown in FIG. 3 and depicted by reference numeral 300. The communications module 300 is similar to module 210, but is designed to provide a conversion of the controller device host protocol to LonWorks FT-10. In this embodiment the circuit 302 presents electrical and logical protocol in the form of LonWorks FT-10 to the connector receptacle 304. In order to accommodate the LonWorks FT-10 connector 304, a complementary LonWorks FT-10 connector plug 306 is provided for connection to a LonWorks FT-10 Control Network 308. It will be appreciated that the circuitry 310 in this module is different to the circuitry 230 in the embodiment of FIG. 2, since it converts the internal communications protocol into LonWorks FT-10. The other elements in this embodiment are similar to those in the communications module of FIG. 2 and are therefore depicted by the same reference numerals.

Yet another embodiment of a communications module of the present invention is shown in FIG. 4 and depicted by reference numeral 400. The communications module 400 is similar to module 210, but designed to provide a conversion of the controller device host protocol to a wireless protocol such as WiFi, Bluetooth, Zigbee, LTE, HSPDA+, GSM, etc. The circuitry 402 of this module therefore supports wireless technology (e.g. WiFi, Bluetooth, LTE, HSPDA, GSM, etc.) as depicted by the antenna 403 which includes the physical wiring, circuitry and antenna design to match the wireless technology. Again, those elements of the communications module 400 that remain the same as that of FIG. 2, are depicted using the same reference numerals.

FIG. 5 shows an embodiment of a communications module 500 acting as USB “pass through” adapter. The module 500 includes a USB connector 502, designed to extend the USB signals present on the connector 252 to devices external to the enclosure 240 of the controller device (FIG. 2) if desired. This embodiment accommodates the scenario where the host protocol is USB based. This configuration it can be considered as an “extension” or “pass through” module. By providing a USB port 502 for external access it allows a USB device, like a dongle, to be plugged into the module 500 Alternatively the USB connector 502 could be mounted internal to the module for use in applications where the USB device is supplied with the communications module. Electronic circuitry is provided on the communications module to convert electrical and protocol signals from the protocols present on the communications module connector 252, such as logic-level SPI or logic-level SCI, to USB, to allow the communications module 500 to act as a host adapter to USB peripherals.

Another embodiment of a communications module is shown in FIG. 6 and depicted by reference numeral 600. The module 600 is similar to module 210, but is designed to provide a conversion of the controller device protocol to traditional analog and digital I/Os, such as relay controls, push-button inputs, temperature, voltage, humidity, etc. It therefore includes circuitry 602 to interface the communications protocol to physical inputs or outputs, to allow measurement, for example, of temperature, voltage, pressure, etc. This includes standard conversion circuitry such as A/D converters, current sensing circuitry, signal conditioning, amplifying, filtering etc. A connector 604 allows the connection of the module 600 to the physical circuits.

FIG. 7 shows yet another embodiment of a communications module 700. The communications module 700 acts as an adapter to another connector, e.g. Mini PCIe. The module 700 includes a connector 702, eg. Mini PCIe, which allows further modules to be installed into the communications module 700.

Another embodiment of the invention will be described with respect to a controller device implementing a LonWorks FT-10 communications interface. A prior art controller device 800 implementing a LonWorks FT-10 communications interface is shown in FIG. 8. It includes a host CPU 802, typically implementing the upper layers of the Echelon “ShortStack” protocol, namely the ShortStack API and ShortStack serial driver, as well as the application programs for the Controller Device 800. A Neuron Integrated Circuit 804 (e.g. FT5000, FT6000 etc.), acting as the ShortStack Micro Server, and implementing the layers 1 to 6 of the “ShortStack” interface is connected to the CPU 802 by means of a parallel IO, SPI or SCI interface 806, which carries Echelon's “Parallel MIP or Serial MIP protocol. A connector 304 allows the controller device 800 to be connected to a controller network.

In accordance with one embodiment of the invention, shown in FIG. 9, a controller device 900 implementing a LonWorks FT-10 communications interface is simplified by eliminating the Neuron Integrated Circuit 804 and connector 304, and replacing them with a connector 250 (similar to the connector in the embodiment of FIG. 2). The remaining elements of the controller 900 remain the same as the prior art device of FIG. 8, namely CPU 802 and parallel IO, or logic-level SPI or SCI interface 806. The same reference numerals have therefore been retained to define similar elements as in the controller device 800.

In accordance with the invention, a communications module 950 is provided that contains a Neuron Integrated Circuit 804. Like the communications module 300 of FIG. 3, the communications module in this embodiment includes a LonWorks FT-10 connector 304 for connection to a LonWorks FT-10 network. It also includes a communications module connector 252 for connecting the module 950 to the connector 250 of controller device 900. As shown in FIG. 9, the module 950 also includes a parallel JO, SPI or SCI interface 806, similar to that in the controller device 900. The communications module 950 converts the ShortStack protocol into LonWorks FT-10, however, in other embodiments conversion to LonWorks MFT, PLC and other LonWorks protocols is also anticipated.

Yet another communications module 1000, shown in FIG. 10, contains electronic circuitry 1002 to translate the ShortStack protocol via parallel 10, SPI or SCI interface 806 to an alternative protocol, e.g. BACnet MS/TP. A connector 208 (which in this embodiment is similar to the connector 208 used in the module 210 of FIG. 2) is used to connect the module 1000 to a control network. Like the embodiment of FIG. 9, the module 1000 is provided with a communications module connector 252 for connecting the module to a complementary connector such as the connector 250 of controller device 900 in FIG. 9.

In another embodiment, shown in FIG. 11, a communications module 1100 contains electronic circuitry 1102 to translate the ShortStack protocol via a parallel IO, SPI or SCI interface 806 to an alternative protocol, e.g. BACnet IP. Again, the module 1100 is provided with a communications module connector 252 for connecting the module to a complementary connector such as the connector 250 of controller device 900 in FIG. 9. A connector 232 (which in this embodiment is similar to the connector 232 used in the module 220 of FIG. 2) is used to connect the module 1100 to a control network.

Many other conversions, for example, to Wi-Fi, ZigBee, etc. are also anticipated.

FIG. 12 shows an embodiment of a controller device 1200 that supports multiple communications modules. The device 1200 includes a plurality of communications module connector receptacles 1202 which allows multiple communications modules of the same or different types to be plugged in. As shown in FIG. 12, electronic circuitry 1204 is included, which may include integrated circuits and microcontrollers, allowing the support for multiple communications modules. Reference numerals 1206, 1208 depict connectors for power, further communication protocols, IO etc. In this embodiment, the multiple communications module connector receptacles 1202 are of the same type as receptacle 250 of the FIG. 2 embodiment, and are compatible with complementary connectors 252 to allow multiple communications modules to be installed in a bus arrangement. These connectors could also be implemented in a vertical arrangement to allow denser packing arrangements.

In order to allow external devices to access the bus of connectors 1202, this embodiment includes a connector 1210. In this way TIA-485-A or USB, for example, can be directly distributed to the connectors 1202. In the case of USB, it will have to be distributed by USB hub circuitry, which can be accommodated in the circuitry 1204. Thus the connector 1210 could also be a USB connector to the popular Raspberry Pi ‘hobbyist’, or other, Single Board Computers (SBCs) or controllers.

In order to support the popular ‘hobbyist’ or prototype Single Board Computers such as the Arduino, BeagleBone Black, Intel Galileo, etc., header connectors 1220 are included. Header connectors 1230 for the popular Raspberry Pi ‘hobbyist’ Single Board Computer, are also included in this embodiment.

Another adaptor is shown in FIG. 13, which supports the Arduino ‘hobbyist’ Single Board Computer. Assembly 1300—is arranged mechanically to comply with Arduino “Shield” boards, and includes connector(s) 1220 in order to interface the Arduino circuitry with connector 1202. In the FIG. 13 embodiment, the adaptor 1300 includes only a single header connector 1202.

An embodiment of an adaptor 1400 with a single communications module connector 1202 and support for a “Raspberry Pi” Single Board Computer, is shown in FIG. 14. This allows for connection of a “Raspberry Pi” Single Board Computer via header connector 1230 to the communications module connector 1202.

FIG. 15 shows another aspect of the invention, in which an adaptor and communications module are connectable to define a communications bridge, router, or gateway. For ease of reference the term “router” will be used in this application to refer to any one of a bridge, gateway, or router. In this embodiment the module 1500 supports An alternative TIA-485-A based protocol. The adaptor 1502 and module 1500 are provided with complementary connectors 1510, 1512, respectively. Circuit 1520 depicts a circuit carrying the forwarded TIA-485-A based protocol. The module 1500 connects to a communications network via a connector 1530. The adaptor 1502 includes a level converting circuit 212 similar to the discussed above with respect to the module 210 in FIG. 2. It will be appreciated that any possible protocol/electrical combinations are possible.

Another communications module arrangement similar to that in FIG. 15, is shown in FIG. 16, which includes a communications module 1500 similar to that in FIG. 15, and an adaptor 1600, to act as a communications bridge, or router, or gateway. In this case some Ethernet based protocol is supported. The adaptor 1600 includes many of the functional elements provided in the module 220 of FIG. 2. Similar elements are therefore depicted using the same reference numerals. The circuit 230 carrying the forwarded communication protocols, in this embodiment, supports Ethernet 10/100baseT. As in the embodiment of FIG. 15, the module 1500 and adaptor 1600 of FIG. 16 are provided with complementary connectors 1510, 1512 to allow the module 1500 to be connected to the adaptor 1600.

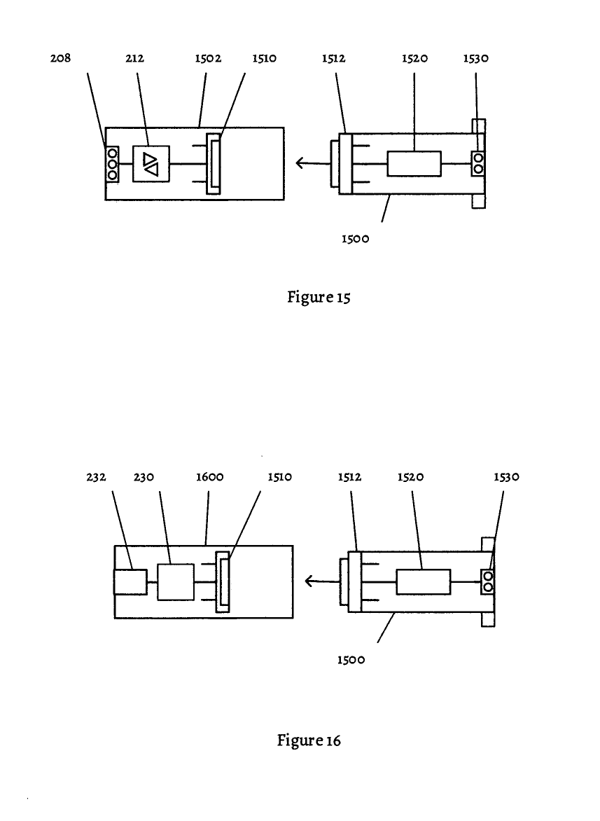

Yet another adaptor embodiment of an adaptor is shown in FIG. 17. The adaptor 1700 defines a USB to communications module adapter, containing a USB interface 1702 and a communications module connector receptacle 250.

### Operation

Usually, a controller device manufacturer, or Original Equipment Manufacturer (OEM) has to choose, from a list of many conflicting requirements, and many protocol options, in deciding which protocol to implement to allow their Controller Device to communicate with other controller devices on a Control Network. The choices involve both the physical media (e.g. TIA-485-A vs LonWorks FT-10), as well as the protocol, which can be different even if the physical media is the same. For instance Modbus and BACnet MS/TP can both operate over TIA-485-A.

Compromises typically have to be made, for example, in the embodiment of FIG. 1, both TIA-485-A as well as Ethernet 10/100baseT are supported. This provides an installer, systems integrator, or user, with two choices when the controller device is installed, but by definition, one of the connections is going to remain unused, and therefore the cost of the unused circuitry and connectors is wasted.

An alternative is for the OEM to have two different models, and each model implements only one of the alternatives. There are costs associated with this as well: inventory costs, multiple SKU costs, multiple design, support and licensing costs etc. Again this is not an ideal situation.

In addition, neither of these approaches allows the OEM to address all of the possible protocol choices that are available. Also, the protocol choices are continually expanding, so there is no way that the OEM can address protocols that are not in existence at the time of their product design.

According to the invention, the manufacturer's quandary is addressed by providing a simplified controller device layout, for instance controller device 200 described above with respect to FIG. 2. This eliminates the specific protocol circuitry 112, 130 found in the prior art controller shown in FIG. 1, as well as the associated connectors 108 and 132, and replaces these with a communications module connector receptacle 250 as show in the embodiment of FIG. 2. This connector, associated electrical circuits and mechanical design of the simplified controller device 200 is such that any one of a selection of communications modules 210, 220, 300, 400, 500, 600, 700, etc., can be inserted, thereby leaving the choice of the communications method to the system integrator, user or installer. The communications modules themselves all have the same electrical, protocol and mechanical interfaces to the OEM controller device 200, so that any communications module can be used with the simplified controller device 200.

In the simplest case, to achieve the lowest costs, the most basic communications module, such as module 210, could be selected for delivery (or stocking in inventory). This module provides the minimum possible functionality to allow the protocol information on circuit 110 to be interfaced with the physical control network 122, thereby allowing the OEM to deliver a minimum viable product (MVP), but retain the ability to add more sophisticated “Added Value” protocol support at a later date. In the MVP case, the Communications Module 210 contains only a single logic-level to TIA-485-A Integrated circuit.

It will be appreciated that this flexibility does have a cost, in terms of the additional printed circuit board (PCB) that is required, the extra two connectors 250, 252, the mechanical mount 256, and the wasted PCB space on the Controller Device itself, but the benefit of making this arrangement can to a very large extent be compensated for by allowing the flexibility of choice of protocols.

A design and marketing goal should be to ensure that the Basic Communications Module 210 is sold at an extremely attractive price to encourage adoption, while allowing fa-flexibility.

The selection of the two most widely used protocols, namely BACnet or LonWorks, as the host protocol allows the interface to the host processor 102 to be standardized and kept as simple and consistent as possible. The modular approach makes it useable in simple use-case scenarios, while at the same time allowing the value added enhanced support as provided by more sophisticated controller devices, to be selected if necessary or desired.

### Benefits of Standardizing on BACnet, LonWorks, or Modbus (Specifically) and on a Modular Approach (Generally)

By concentrating initially on one main protocol, provides OEMs with reduced time to market since they only have to implement one host protocol, namely BACnet, Echelon ShortStack (LonWorks), or Modbus, which can be provided at very low cost, or free, and/or as an engineering service to enable them to adopt the communication module technology faster.

It will provide the ability to choose the Control Network Protocol at the time of installation, rather than at time of manufacture.

It provides the ability to field-upgrade the modules in the case of bug fixes or technology changes.

In some cases it will be literally impossible to choose the communication method a priori. For example, choosing a cellular data carrier is dependent on the cellular carriers available in the customer area at the time of installation, and in addition, the cellular service provider or technology may change over time. Using modules allows the choice to be made at installation time and also for the technology, or cellular service provider, to be updated easily.

An OEM taking the traditional approach to design and manufacture a controller device such as the prior art device 100, would require their controller device to be approved by multiple regulatory bodies, CE, UL, FCC, as well as cellular data carriers, ATT, Verizon etc. With a non-modular approach, since addressing each technology would require a redesign of the controller device 100, OEMs would have to go through this approval process with each of the different protocols each time.

In contrast, with a modular approach, the modules are pre-approved, and the OEM only has to apply for a subset of the above approvals, and only once. This can save the OEM substantial time and cost.

A sophisticated communications module can be used in a programmer or configurator role to configure a controller device 200. This programmer module may have interfaces, for example, to a keyboard, display, mass storage, or wireless connectivity to a smart phone or even the control network or Internet, to allow a suitable user interface to access the controller device to allow configuration input. Once programmed, or configured, the programmer module can be replaced by a cheaper, application specific communications module. This reduces the connection count for programming devices, and allows controller devices to be programmed locally, or remotely, even if not connected to the final control network.

Similarly, more sophisticated diagnostic modules can be used temporarily until control network problems are diagnosed and resolved.

In the prior art scenario if an OEM wants the ability to optionally provide a sophisticated protocol such as BACnet/IP, then the microcontroller 102 in controller device 100 would need the CPU power and available RAM and program memory to support the IP stack for BACnet/IP, even if BACnet/IP is not used.

In contrast, using a controller device of the invention such as the embodiment shown in FIG. 2, allows a smaller, cheaper, microcontroller to be used in the design, because the additional CPU power and program memory etc. is supplied by the communications module 210, and only if used.

### Communications Module Connector Details

The electrical circuits associated with the Communications Module Connectors 250, 252 have been carefully chosen. The selection of circuits, and the fact that there are multiple possible circuits, is one of the cornerstones of this invention. It should be noted that not all the possible circuits have to be implemented in every use case, but the fact that the circuits are reserved allows the interchange of communication modules without requiring the OEM to re-program the controller device. In our embodiment, support is therefore provided for: Power—One or more contacts on the connectors are to be used for circuit common or 0V and a few more for system power. This has been nominally set to a range 3.3 to 5.0 volts to accommodate most cases of electronic Controller Device designs today. In some use-cases, for example, if Power over Ethernet (POE) is implemented, the communications module can provide power to the controller device.

TIA-485-A—Two circuits are used, one for the inverting ‘A’ signal and another for the non-inverting ‘B’ signal. This allows multiple modules to be installed on a bus 1202 as shown in FIG. 12, but also allows the modules to be easily interfaced to pre-existing TIA-485-A circuitry.

USB 2.0—Two circuits are to be used for USB 2.0, this being a very common standard these days. The USB connections can either be fed to the onboard circuitry 260 for use by the communications interface electronics, or they can be used in a “pass through” mode as in the module 500 shown in FIG. 5.

SPI, SCI—these are two logic level interfaces, basically serial protocols with clock and enable lines. SCI includes the ubiquitous UART serial communications too. Since only one protocol is expected to be used at a time, many of the circuits can be shared if necessary. While in the present embodiment the connectors 250, 252 have been chosen to support the above contacts, in other embodiments, the complementary connectors may have fewer or more pins to support only a sub-group of the contacts or additional contacts, provided there is a de facto standardization to readily allow communications modules to be replaced in a plug-and-play fashion, thereby allowing the controller device of the invention to easily communicate with a different external protocol.

One aspect of this invention is to focus on a robust, simple expandable protocol for the host protocol 110, such as logic level BACnet MS/TP, allowing full communication capability even with a minimal configuration, yet retaining the flexibility to add functionality if need be by substituting the simple communications module with a more sophisticated implementation of the protocol

If the OEM were to choose logic level BACnet MS/TP for their host protocol, then by inserting the basic communications Module 210 they would have a 100% BACnet MS/TP compliant system. As mentioned before, the basic communications module 210 will be designed and sold as cheaply as possible to partially compensate for the additional cost of using modules.

Once logic-level BACnet MS/TP has been chosen for the host protocol 110, further enhancements are possible. BACnet has a standard file transfer protocol, which allows various configuration and operational parameters to be sent to the controller device 200, or even to the communications module itself, via BACnet. This file can be utilized by the host microcontroller 102 or by other communications modules 220, 300, 400 etc., as their configuration settings.

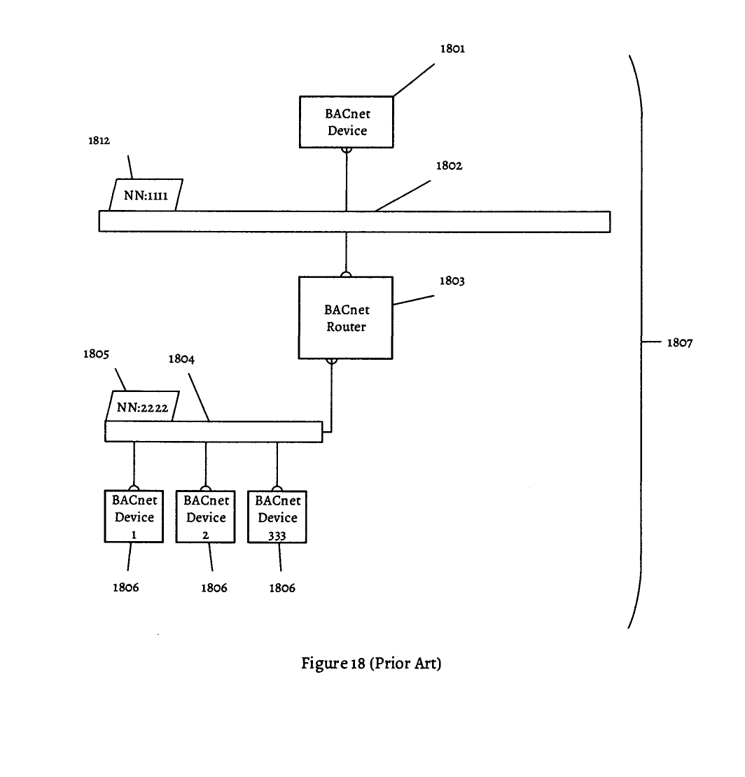

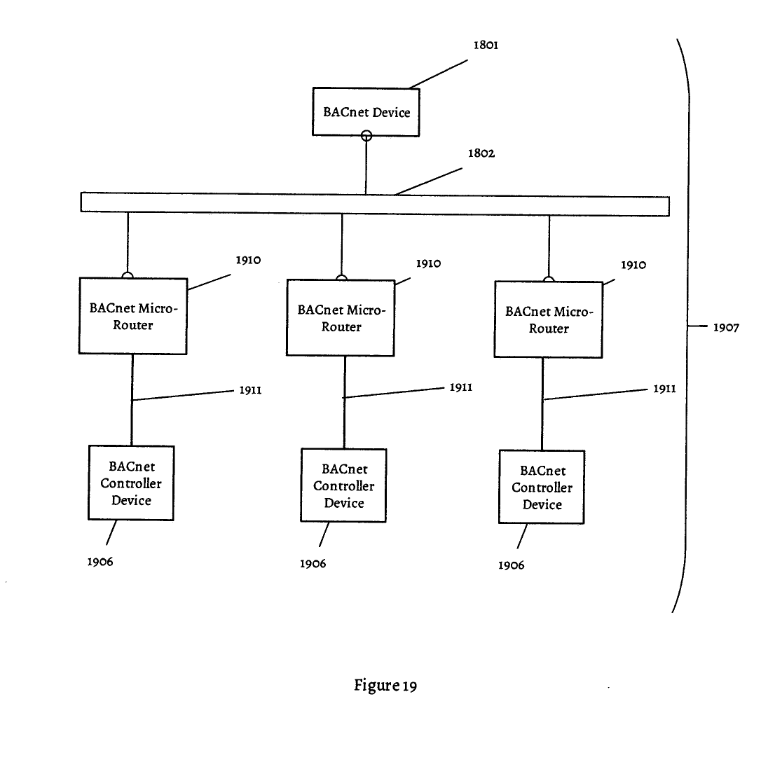

Another feature of the invention is that if logic-level BACnet MS/TP has been chosen for the host protocol, and more sophisticated modules, such as the Ethernet module 220 are used, then the Ethernet module 220 can act as a proxy or BACnet Micro-router to the BACnet Controller Device 200 as is discussed in greater detail below with respect to FIGS. 18 and 19. This means that parameters such as Max Masters, Baud Rate, Network Number, MAC address etc. for the controller device 200 are either no longer necessary or can be derived automatically. This enables “Zero Configuration” or “Plug and Play” capabilities in the Communication Modules. In fact, as will become clearer from the discussion of micro-routers below, with respect to FIGS. 18 and 19, the communications module 220 is effectively a BACnet micro-router of the invention. This allows controller devices that are designed for BACnet MS/TP to easily support BACnet Ethernet or BACnet/IP as field-replaceable options.

Modules with the same hardware, but different software can be supplied at different pricing levels. For example, the same hardware can be used for a BACnet/IP “polled” system, as wellas a BACnet/IP COV application. This allows for low initial pricing for BACnet/IP and additional pricing for BACnet/IP COV to encourage widespread initial adoption at lower costs, but still provide further functionality if required, albeit at a higher cost. Further functional enhancements could include BACnet Trending and Scheduling, etc.

Modules with additional hardware as well as software functionality, for example BACnet Security and Encryption, can be substituted for their more basic counterparts, thus relieving the OEM from having to provision all controller devices with the additional functionality and cost if this functionality is not required. This allows unsecured Control Network to be upgraded to a secure level at a later date. Also, if for any reason a secure Control Network is compromised, then all controller devices with communications modules installed can be rapidly re-secured by replacing the modules with new secured modules.

Additional hardware, such as NFC (Near Field Communications) 306 for configuration, or Real Time Clock hardware, could be implemented in more sophisticated, and therefore more expensive communications modules, to be used only when required.

More expensive, but sophisticated diagnostic modules, for example, packet filtering inspection, capturing and forwarding, can be installed on control networks that are not working properly. Once the control network problems are diagnosed, the expensive diagnostic modules can be replaced by cheaper operational modules.

The voltage levels of the connected control network, such as control network 308, could be sampled by an onboard electronic subsystem 310 and the results provided to a diagnostic PC or device, which can show the samples in various formats such as an oscilloscope view, a spectrum analyzer view, an Eye-diagram view etc., allowing a qualified operator to observe the electrical health of the control Network. This allows the Communications Modules to act as a virtual oscilloscope, protocol analyzer, logic analyzer, DMM or Spectrum Analyzer.

Another prior art controller device is shown in FIG. 8, making use of Echelon's protocol and integrated circuit. Echelon's Neuron integrated circuit 804 has the ability to connect via their “ShortStack” interface to a host processor 802. The host microcontroller 802 runs the application software for the controller device 800, as well as Echelon's “Short Stack API” and “ShortStack serial driver”. This allows the more powerful host processor 802 to use the Neuron integrated circuit 804, running the “ShortStack Micro Server”, as a communications control network transceiver to an FT-10 (or other Echelon physical layer based) control network. Even though it is a common configuration, since the integrated circuit 804 has been designed into the controller device 800, a connection to another communications control network, even if it is still a control network using Echelon's technology, such as MFT, PLT etc. is impossible without a different hardware redesign of the whole controller device 800.

Making use of the invention's modular approach, on the other hand, would allow the OEM to design a controller device 900 as shown in the embodiment of FIG. 9, with a communications module connector 250 but removing the Neuron integrated circuit from the design of the controller device 900. If connectivity to FT-10 is desired, then an FT-10 communications module 950 can be field installed. This module 950 contains the Neuron integrated circuit 804 with the ShortStack Micro Server and provides a continuation of the ShortStack connection 806 via the communications module connectors 250 and 252. Electrically and functionally, the combination of controller device 900 and communications module 950 is equivalent to the Controller Device 800.

However, if connectivity to a different communications control network is required, for example, Echelon MFT, then a suitable communications module is installed instead of the module 950. In this way connectivity for other Echelon control network technologies is straightforward and transparent.

The Neuron integrated circuit 804 can also be replaced with an alternative technology as shown in module 1000. Integrated circuit 1002 converts the ShortStack serial protocol 806 to any other protocol, e.g. BACnet MS/TP and presents this alternative protocol to connector 208. Mapping data points from LonWorks to the other protocol takes place in the microcontroller and associated electronic circuits 1002.

Of course, mapping of protocols is not limited simply to mapping from ShortStack to BACnet MS/TP. For example, module 1100 illustrates how mapping from ShortStack to BACnet/IP is possible using another microcontroller 1102 for the protocol and data point conversion.

In all cases, if Modbus is chosen as the host protocol, then in order to simplify the configuration of the communications module, the communications module can probe the OEM controller device for numerical patterns in the registers to establish a “fingerprint” and then select a Modbus register mapping configuration suitable for the control network protocol, from a database of configurations filtered by the controller device's fingerprint. This database can be internal or external to the communications module, or could even be in the Cloud, and the fingerprints of different controller devices with their filter patterns could be crowd-sourced, or set by the OEM, systems integrator or user.

Alternatively a single Modbus register can be assigned to act as a configuration selector, where the ultimate module configuration is specified by the value in the register.

Because establishing a unique device identification is critical for reliable and deterministic control network operation, the subject deserves further consideration. The communications modules use a range of methods to set the unique device ID:

In the case of LonWorks, Pushbutton (Service Pin) identification is built in to the standard, and does not need further discussion here.

On the other hand Pushbutton identification is not currently accommodated by the BACnet standard. Several embodiments of the communications modules will support the emerging IEEE 1905 protocol standard, and as such, have access to the Unified Security Setup Procedure that provides a MAC address or device identification to the application using the IEEE 1905 stack for data transfer and discovery. This invention incorporates the IEEE 1905 Unified Security Setup Procedure, and uses the identification thus provided to automatically set the BACnet Device Instance Number, as well as using an ASCII representation of the numerical to create the BACnet Device Object Name.

In addition, the 1905 protocol provides a NFC (Near Field Communications) based method of setting the same parameters, and in a similar fashion, the communications module may use the IEEE 1905 Unified Security Setup Procedure's NFC methods to provision the BACnet requirements.

Some BACnet based controller devices are able to access the unique Ethernet “EUI-48” MAC address and can be used to provision the BACnet requirements.

NFC (Near Field Communications) can be used directly, without the presence of IEEE 1905 protocol layers, to provision the BACnet (and other protocol) requirements.

NFC can be used for the distribution of Security Keys for BACnet Security layer.

In all cases, NFC could be passive (as in “Smart Card” or active, as in the use of a Smart-Phone). Flashing LEDs, beeping sounds in a series of bursts, or in a code, e.g., Morse code, can be used to identify a controller device by audio or visual means, and then used to match this controller device to the controller device's address in a database using the observer's input via a simple user interface, running either on a PC or a Smart-Phone (such as an Apple iPhone, or Android based phone).

Once again, a more sophisticated communications module could be used for configuration, and subsequently replaced with a simple communications module for normal operation.

### Adapters

Communications modules as discussed above are designed to be plugged into controller devices like the device 200 depicted in the embodiment of FIG. 2. However, with adapters, they can find further use in other configurations.

For example, adapter 1502 allows a communications module 1500 to be adapted into a TIA-485-A gateway. Similarly, adapter 1600 allows a Communications Module 1500 to be adapted into an Ethernet gateway.

Adapter 1700 allows communications modules to plug directly into a PC or some other USB 2.0 Host by means of a USB connector 1702 on the adaptor 1700.

Adapter 1300 allows communications modules that are plugged into the adaptor to interface with Arduino Single Board Computers viathe Arduino “shield” interface.

Adapter 1400, in turn, allows communications modules to interface with Raspberry Pi Single Board Computers.

It will be appreciated that other adaptors could be configured for any number of other hardware platforms, e.g. “SmartDuino”.

As was mentioned above, the use of a communication module lends itself to the implementation of a plug-and-play scenario for devices by providing a micro-router, as is discussed in greater detail below.

Consider a prior art Internetwork as depicted in FIG. 18. BACnet Internetwork is a term defined by the ASHRAE BACnet standard to describe a collection of BACnet controller devices 1806, which are able to communicate with each other using the BACnet protocol over various physical networks 1802, 1804. Since the two physical networks have different BACnet Network Numbers, and are of different physical types, they need to be linked together by a BACnet Router 1803. For clarity the Network Numbers of the two BACnet Networks 1802, 1804 are indicated in the label boxes 1812, 1805.

A BACnet Router 1803 is responsible to receive a packet from any one of the BACnet devices 1801, 1806 on the BACnet Internetwork 1807 and forward the packet to the final destination. It does this by establishing the MAC address of the sending device and examining the destination address of the packet, examining its internal address tables and forwarding the packet to the appropriate device or router. When forwarding the packet, it adds the Network Number of the BACnet Network that the packet was received from, as well as the MAC address of the sending device, so that other devices know what address to respond to. The Network Numbers of the attached networks, that are normally required for forwarding packets, are parameters that have to be configured by the user.

There are, however, burdens associated with a BACnet Router 1803 in a BACnet Internetwork 1807.

These BACnet Routers 1803 need to be configured to contain Network Numbers for each of the attached BACnet Networks 1802 and 1804.

All BACnet Devices 1806 have to have unique, non-conflicting MAC addresses on a given BACnet Network 1804. On a BACnet MS/TP network, these are typically set by DIP or rotary switches on each node. Any conflict in MAC address setting can result in all devices not being able to communicate.

The BACnet Router needs to have its own MAC address set for each of the connected BACnet Networks.

A misconfiguration can prevent the whole BACnet Internetwork 1807 from working properly. BACnet Networks such as 1804, often implemented using TIA-485-A as a physical medium, are relatively slow and create a traffic bottleneck when many devices 1806 are added to a single bus. TIA-485-A also necessitates running a special, twisted pair cable between all devices 1806 in a building that is often pre-wired for Ethernet.

A badly terminated, badly wired, or failed BACnet device 1806 can also cause the whole BACnet Network 1804 to fail electrically, rendering all devices unable to communicate.

Because the user has to be able to set parameters in the BACnet Router 1803, there has to be a special user interface, normally a built-in webserver to allow this operation. This necessitates a CPU with more memory and cost than is required for the actual routing operation.

FIG. 19 shows an embodiment of a BACnet Internetwork in accordance with the invention. Because it is similar to that of FIG. 18, similar elements are depicted using the same reference numerals. However, in this case, the standard BACnet Router 1803 has been replaced by a multitude of BACnet micro-routers 1910, one micro-router for each BACnet device 1906. The single BACnet Network 1804 has likewise been replaced by three BACnet Networks 1911. It will be appreciated that the BACnet controller devices 1906 can be implemented as simplified controller devices, as was discussed above for the modular communications modules. The micro-routers 1910 will then be implemented as modular routers that can be plugged into the BACnet controller devices 1906 by making use of complementary connectors on the controller devices 1906 and micro-routers 1910.

The effect of this is that in accordance with the invention the BACnet Packets are not examined and forwarded as in a standard BACnet router, but instead, the micro-routers 1910 each act as a proxy to a single BACnet device 1906. The BACnet Networks 1911 are ignored and the Network number of Networks 1911 and the MAC address of devices 1906 are not added to the packet when forwarding BACnet packets. In fact, by implementing the micro-routers 1910 as pluggable devices as described for the communications modules above, the BACnet Networks 1911 are, in effect, eliminated. Instead, the MAC address of the BACnet micro-router 1910 only is used. The peer devices thus respond to the MAC address of the BACnet micro-Router 1910 when responding, rather than to the BACnet controller device 1906. The BACnet micro-router knows that it is acting as a proxy to the BACnet controller device 1906 and since only one such device is present on the BACnet Network 1911, it is able to forward the packet to this device even though the device's address is not present in the packet. If the physical network 1802 is Ethernet, Ethernet/IP, WiFi etc., with pre-configured (factory configured) MAC addresses, the user no longer has to set the MAC address.

In addition the BACnet micro-routers 1910 do not have a ‘BACnet Presence’ on the BACnet Internetwork: they do not have BACnet Instance numbers of their own, or BACnet Device Object Names of their own, but rather present the parameters from the BACnet controller devices 1906 to the BACnet Internetwork 1807 when receiving a query. In this fashion the BACnet micro-routers 1910 are completely transparent to device discovery, and act as proxy devices to the BACnet controller devices 1906.

Installing the BACnet Micro-routers eliminates all of the above issues:

The BACnet Micro-router, because it is attached to one and only one BACnet controller device 1906 at a time, can present itself to the rest of the BACnet Internetwork as a single proxy device for the BACnet controller device 1906 it is connected to. It presents its own MAC address to the other devices on the BACnet Internetwork, and the other devices on the BACnet Internetwork. They will address the pair of devices 1910 and 1906 as a single device with no intervening network 1911. This eliminates the need to configure any Network Number for BACnet network 1911. In a similar fashion, the need to configure a Network Number for Network 1802 is eliminated. Since there is one, and only one, BACnet device on BACnet Networks 1911, the MAC address of the BACnet controller device 1906 can be set to any value. This requires that the BACnet Micro-router 1910 ‘discovers’ the MAC address of BACnet controller device 1906, but this is relatively trivial to achieve. Note that the Baud Rate, if relevant, for BACnet Network 1911 can also be ‘auto-discovered’, eliminating a further configuration requirement.

Because there is only one BACnet controller device 1906 on BACnet Network 1911, as soon as this address is discovered, the BACnet Micro-router 1910 can automatically set its own address to be any of the remaining free MAC addresses in the allowed range of MAC addresses for the BACnet Network 1911 without fear of conflict. The MAC address for the BACnet Micro-router 1910 facing the BACnet network 1802 can be auto-established using DHCP (if BACnet Network 1802 is BACnet/IP), or use the Ethernet MAC address (if BACnet Network 1802 is BACnet Ethernet), or whatever local mechanism is used by the BACnet Network 1802, including the method described in paragraph 2 above, if the BACnet Network 1802 is TIA-232-A. Because all parameters are ‘auto-configured’, there is no chance of a misconfiguration. Since there is now only one BACnet controller device 1906 per BACnet Network 1911 and BACnet Micro-router 1910, throughput is maximized to the theoretical maximum for BACnet Networks 1911.

Now that it is possible to have a BACnet Micro-router 1910 near every BACnet controller device 1906, if there is a nearby building network Ethernet switch (or wireless Access Point in the case of WiFi physical layers) nearby (as is often the case), special cabling can be largely eliminated.

A badly terminated or wired TIA-485-A device, will at most, only render that one, single device unable to communicate, not the whole network of devices.

Now that every parameter is auto-configured, there is no need for additional user interfaces at all, and just the very cheapest devices can be used.

The use of micro-routers provides certain specific benefits by allowing the router to add functionality to a device that is otherwise missing from the device. For instance, the BACnet specification contains a particular service, called Change Of Value (COV) which reduces network bandwidth consumption by allowing one or more BACnet Devices to register with a data property of interest, and once registered, and only when suitable conditions are met, such as a change of value out of a configured delta range, is a message generated on the network. This has the great benefit of eliminating the need to continuously poll for the data. However, not all, and indeed most, simple devices do not support this powerful option. The BACnet Micro-router 1910 can act as a proxy for these simple devices, polling for the data from the simple device 6 in a controlled fashion, and then providing this data as a COV service to other devices that desire to subscribe to changes in the data value. Other services can also be provided using this proxy approach.

The voltage levels of the connected network 1911 can be sampled by an onboard electronic subsystem and the results are provided to the diagnostic PC which can show the samples in various formats such as an oscilloscope view, a spectrum analyzer view, an Eye-diagram view etc. etc. allowing a qualified operator to observe the electrical condition of the network 1911. Problems such as signal attenuation, electrical noise, mis-wiring, ground loops and other electrical problems can be identified in this way.

In addition, resistor networks and other electronic circuits can be electronically temporarily or permanently added to the connected network to allow, through a series of tests, the diagnosis of the termination and biasing condition of the network.

In the embodiment of FIG. 19 the network 1802 is Ethernet and Networks 1804 and 1911 are TIA-485-A. However, it will be appreciated that the principles outlined may be used with other physical layers, e.g. LonWorks, 6LoPAN, WiFi, etc.

In this description, all the processing is described as taking place in the BACnet Micro-routers themselves. However, in order to further reduce the hardware and software requirements for the micro-router, the BACnet micro-routers can forward all packets received from all devices on all networks to a central ‘Master Router’ device which can make all the routing table lookups and subsequent routing decisions, and return the packets with modifications and instructions how to forward them to their attached devices as necessary.

The description also describes the routers, networks and devices as a fixed number of devices. It will be appreciated that the principles of the invention apply to any number of each of the different devices 1801, 1906, 1910 on any given BACnet Internetwork 1907.

This process has been described for application with the BACnet Protocol, but may be applicable to other network protocols.

The Communication Module Connectors 250 and 252 described in the above embodiments carry power and four communications types. Another embodiment could however contain more communication types.

It will also be appreciated that communication modules could contain internal, virtual nodes for additional functionality.

Communication modules can also be adapted to enable controller device connectivity to the Internet, the “Internet of Things”, the “Ubiquitous Internet”, the “Internet of Everything” and “the Cloud”.

While the discussion above emphasized the configuration and use of communications modules, it will be appreciated that many of the concepts discussed (for example, the use of NFC for Security Keys) can also be applied to controller devices that do not use the communications module concept. None of the above description need to be limited to the use with communications modules, but could, for example, also be applied to single purpose communications gateways or routers.

The invention describes the use of Modbus, BACnet and LonWorks, but the principles of the invention can be applied to many other protocols as well, such as:

### Metasys N2,

### IEEE 802.3 (Ethernet),

### IEEE 802.11 (Wi-Fi)

### IEEE 1901

### IEEE 1905 (Hy-Fi)

### PLC (Power Line Communications) MoCA

### Megabit Free Topology (MFT) IEEE 802.15

### ZigBee

### Z-Wave

### Bluetooth, Bluetooth LE Sensinode[39]

### Near Field Communications (NFC)

Cellular Data 1xRTT, LTE, GSM, GPRS, HSPDA, HSPDA+ etc. TIA-232, TIA-485-A, Fiber Optic
WiGig (IEEE 802.1 lag)

Similarly, a range of modules, supporting BACnet only, with only the SCI interface, could be created to support just the varied physical requirements (TIA-485-A, Ethernet, TCP/IP, Wi-Fi, TIA-232, ZigBee, etc.) for a BACnet-only Control Network. These modules can, due to their reduced functionality, be made narrower, smaller and cheaper.

As a marketing enhancement, source code for the BACnet MSTP stack could be supplied at very low cost, or even free, to induce the rapid adoption of the ranges of communications modules described herein, as well as ensure greater compatibility between modules.

The communications modules often need persistent storage of configuration parameters. This can be supplied on the modules via EEPROM, FLASH, internal MCU Integrated Circuit persistent storage etc.

Additional contacts on the Communications Module Connectors 22 and 23 can be assigned to a security handshake signal to ensure that modules are duly licensed and authorized for a given site, user or application. NFC and other methods, such as factory presets, could also be installed to ensure the same.

What is claimed is:

1. A BACnet Internetwork, comprising
multiple controller devices communicating with each other according to at least two different protocols, and
at least one micro-router configured to convert between logic-level BACnet MS/TP communications protocol and a second communications protocol, wherein each micro-router defines a replaceable communications module that includes a first connector configured to releasably engage with a complementary connector on a controller device, and a second connector, the micro-router being connectable to only one controller device via its first connector, and the controller device being configured as a BACnet MS/TP controller device in which communications between the micro-router and a CPU on the controller device take place according to logic-level BACnet MS/TP communications protocol.

2. A BACnet Internetwork of claim 1, wherein the second connector is configured to connect the micro-router to a second device or to a BACnet network, communicating according to a different communications protocol.

3. A BACnet Internetwork of claim 2, wherein the micro-routers are configured as dedicated modules that are interchangeably connectable to a BACnet controller device, and convert between the logic-level BACnet MS/TP on the first connector and said different communications protocol.

4. A BACnet Internetwork of claim 2, wherein the different communications protocol comprises one of, BACnet MS/TP at a different voltage level, BACnet Ethernet, BACnet/IP, Modbus, USB, TIA-232, TIA-485-A, MoCA, IEEE 1901.2, IEEE 1905, WiGig, LonWorks, wireless communications, and any communications protocol with added features.

5. A BACnet Internetwork of claim 4, wherein the added features include at least one of BACnet COV, BACnet Security, BACnet encryption, BACnet Trending and Scheduling, and diagnostic functions.

6. A BACnet Internetwork of claim 5, wherein the diagnostic function includes at least one of packet inspection, packet logging, packet forwarding, and voltage level measurements.

7. A BACnet Internetwork of claim 1, wherein the first connector includes contacts to provide support for ground or 0V, for power, and for at least one of TIA-485-A to accommodate a choice of the inverting ‘A’ signal and the non-inverting ‘B’ signal, USB 2.0, logic-level SPI, and logic-level SCI.

8. A modular communications system for communicating data between a controller device, communicating data according to a first communications protocol, and a second controller device or BACnet network, communicating data according to a second communications protocol, comprising
a communications module,
an adaptor for receiving the communications module, and
a first controller device, wherein the communications module and adaptor are configured to releasably engage each other by means of complementary connectors and are configured to communicate with each other according to logic-level BACnet MS/TP communications protocol.

9. A system of claim 8, wherein the communications module is configured to convert between logic-level BACnet MS/TP and a second communications protocol.

10. A system of claim 9, wherein the adaptor is configured to communicate with the first controller device by means of a third communications protocol.

11. A system of claim 10, wherein the first controller device comprises a single board computer and the adaptor includes a header connector for connecting to the single board computer.

12. A system of claim 9, wherein the second communications protocol comprises one of, BACnet MS/TP at a different voltage level, BACnet/IP, Modbus, USB, TIA-232, TIA-485-A, MoCA, IEEE 1901.2, IEEE 1905, WiGig, LonWorks, wireless communications, and any communications protocol with added features.

13. A system of claim 12, wherein the added features include at least one of BACnet COV, BACnet Security, BACnet encryption, BACnet Trending and Scheduling, and diagnostic functions.

14. A system of claim 13, wherein the diagnostic function includes at least one of packet inspection, packet logging, packet forwarding, and voltage level measurements.

15. A system of claim 8, wherein the complementary connectors includes contacts to provide support for ground or 0V, for power, and at least one of TIA-485-A to accommodate the inverting ‘A’ signal and the non-inverting ‘B’ signal, USB 2.0, logic-level SPI, and logic-level SCI.

16. A method of communicating between at least one first device connected to a first communications network and at least one second device in a BACnet Internetwork, comprising
providing each of the at least one first devices with a dedicated micro-router, wherein each micro-router acts as a proxy for its first device by providing the MAC address for communications between its first device and any second device, and using only the BACnet Instance Number and BACnet Device Object Name of its first device for communications with said second device.

17. A method of claim 16, further comprising providing each micro-router and each first device with complementary connectors for releasably connecting a micro-router to a first device.

18. A method of claim 17, wherein the complementary connectors includes contacts to provide support for ground or 0V, for power, and at least one of TIA-485-A to accommodate the a choice of inverting ‘A’ signal and the non-inverting ‘B’ signal, USB 2.0, logic-level SPI, and logic-level SCI.
